(19) United States
(12) Patent Application Publication
(10) Pub. No.: US 2013/0313949 A1
(43) Pub. Date: Nov. 28, 2013

(54) ROTARY ACTUATOR

(71) Applicant: DENSO CORPORATION, Kariya-city (JP)

(72) Inventor: Hidenori FUJII, Kariya-city (JP)

(73) Assignee: DENSO CORPORATION, Kariya-city (JP)

(21) Appl. No.: 13/891,483

(22) Filed: May 10, 2013

(30) Foreign Application Priority Data
May 28, 2012 (JP) 2012-120747

(51) Int. Cl. H02K 7/00

(52) U.S. Cl. CPC H02K 7/003
USPC 310/75 R

(57) ABSTRACT

A casing includes a support tubular part. An input shaft is rotatably supported in the casing. A motor is housed in the casing and rotationally drives the input shaft. An output shaft includes an output tubular part, which is formed in a tubular shape to rotatably couple an end part of a driven shaft in its inside and rotatably supported inside the support tubular part of the casing. The output shaft outputs the rotary force of the motor to the driven shaft with the transfer to the rotation of the input shaft. A bearing member is provided to be supported inside the support tubular part of the casing and rotatably bear the driven shaft in a state that the manual shaft is coupled to the output tubular part of the output shaft.

### CROSS REFERENCE TO RELATED APPLICATION

This application relates to and incorporates herein by reference Japanese patent application No. 2012-120747 filed on May 28, 2012.

### FIELD

The present disclosure relates to a rotary actuator, which rotationally drives a shaft as a driven object.

### BACKGROUND

A rotary actuator is used conventionally as a driving device in a shift-by-wire system of a vehicle. According to a rotary actuator disclosed in, for example, JP-A-2009-177982 (US 2009/0189468 A1), its output shaft is coupled to an end of a manual shaft of a shift range switching mechanism. The rotary actuator thus outputs from its output shaft a rotary power of a built-in motor to rotationally drive the manual shaft.

When this rotary actuator is attached to a vehicle, an outer wall of a top end part of a support tubular part formed on a casing is fitted into an inner side of a hole of a housing of the shift range switching mechanism. The end part of the manual shaft is spline-coupled with an inside part of an output tubular part formed on the output shaft. The output tubular part is supported rotatably inside the support tubular part of the casing. As a result, the output tubular part of the output shaft is supported by the housing of the shift range switching mechanism through the support tubular part of the casing in a state that the rotary actuator is attached to the vehicle.

The end part of the manual shaft is supported only at a coupling part with the output tubular part and not supported at any other parts. For this reason, when the shaft is driven to rotate by the rotary actuator, coaxial relation between the output shaft and the manual shaft tends to be lost. As the loss of coaxial relation increases, the coupling part between the output shaft and the manual shaft is likely to pry or locally wear. The prying or local wear will cause an improper operation of the rotary actuator and generate wear powder.

### SUMMARY

It is therefore an object to provide a rotary actuator, which can maintain a coaxial relation between an output shaft and a shaft to be driven.

According to one aspect, a rotary actuator is provided for rotationally driving a driven shaft of a driven object. The rotary actuator is configured to include a casing, an input shaft, a motor, an output shaft and a bearing. The casing has a support tubular part. The input shaft is supported rotatably by the casing. The motor is housed in the casing to rotationally drive the input shaft. The output shaft has an output tubular part, which is formed in a tubular shape and supported rotatably inside the support tubular part. An end of the driven shaft is coupled with the output tubular part. The output shaft receives rotation of the input shaft and outputs rotary force of the motor to the driven shaft. The bearing member is provided to be supported inside the support tubular part and rotatably supporting the driven shaft in a state that the driven shaft is coupled to the output tubular part.

### BRIEF DESCRIPTION OF THE DRAWINGS

The above and other objects features and advantages will become apparent from the following detailed description made with reference to the accompanying drawings. In the drawings:

FIG. 1 is a sectional view showing a rotary actuator according to one embodiment; and

FIG. 2 is a schematic view showing a shift-by-wire system, which uses the rotary actuator shown in FIG. 1.

### DETAILED DESCRIPTION OF THE EMBODIMENT

### Embodiment

A rotary actuator according to one embodiment will be described below with reference to the drawings.

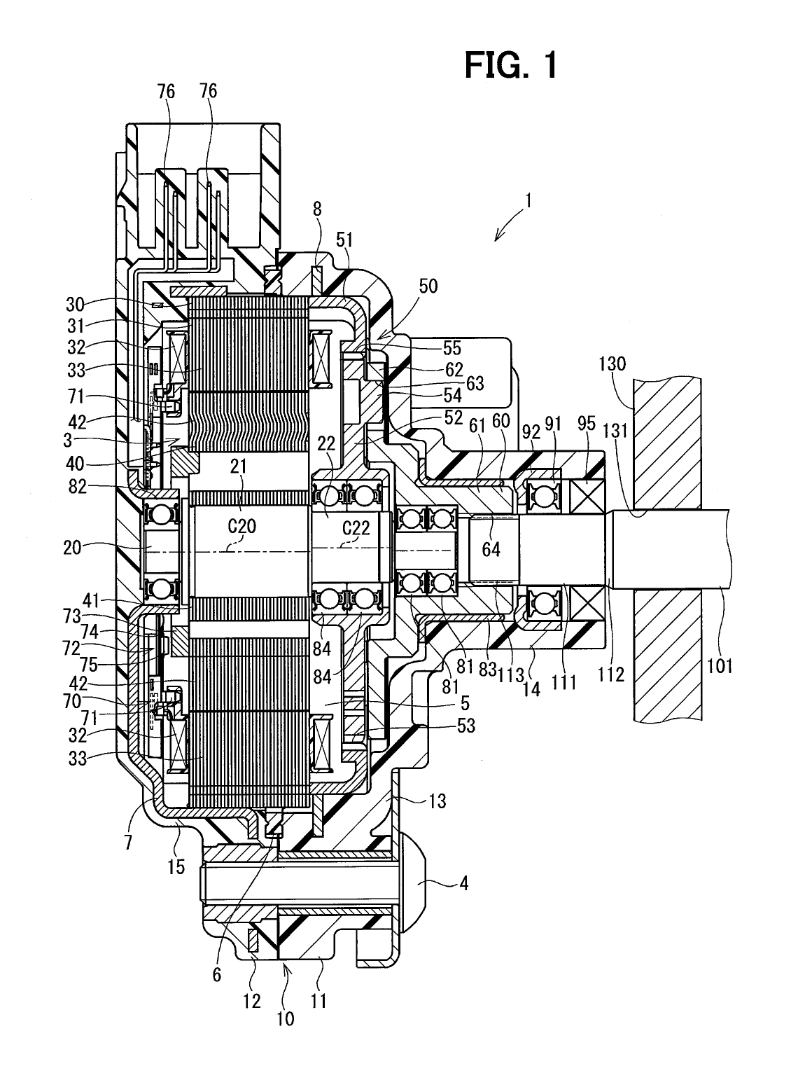

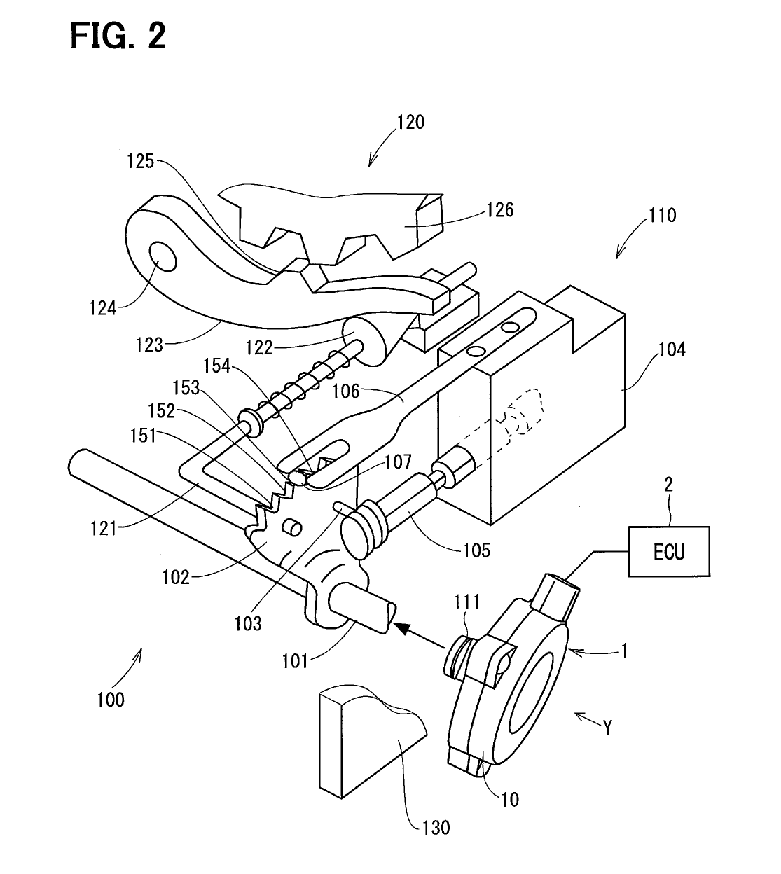

Referring to FIGS. 1 and 2, a rotary actuator 1 is used, for example, as a driving device of a shift-by-wire system 100, which is configured as shown in FIG. 2 to switch over a shift range of an automatic transmission of a vehicle.

As shown in FIG. 2, the shift-by-wire system 100 includes the rotary actuator 1, and electronic control unit (ECU) 2, a shift range switching mechanism 110, a parking switching mechanism 120 and the like. The rotary actuator 1 rotationally drives a manual shaft 101 of the shift range switching mechanism 110 as a driven shaft, which is a part of a driven object, so that a shift range of an automatic transmission is switched over. Rotation of the rotary actuator 1 is controlled by the ECU 2. The rotary actuator 1 is attached to a housing 130 of the shift range switching mechanism 110. The rotary actuator 1 rotationally drives the manual shaft 101 of the shift range switching mechanism 110 thereby to drive a parking rod 121 and the like of the parking switching mechanism 120. The parking switching mechanism 120 is also a part of the driven object.

The shift range switching mechanism 110 includes the manual shaft 101, a detent plate 102, a hydraulic valve body 104, the housing 130 and the like. The housing 130 accommodates therein the manual shaft 101, the detent plate 102, the hydraulic valve body 104 and the like. The manual shaft 101 is provided such that its one end part protrudes from the housing 130 through a hole 131 (FIG. 1) formed in the housing 130.

The manual shaft 101 is spline-coupled to the output shaft 60 of the rotary actuator 1 at its one end part. The detent plate 102 is formed in a fan shape, which expands in the radially outward direction from the manual shaft 101. A pin 103 is provided on the detent plate 102 to protrude in parallel to the manual shaft 101.

The pin 103 is engaged with an end part of a manual spool valve 105 provided to the hydraulic valve body 104. The manual spool valve 105 thus reciprocally moves in the axial direction by the detent plate 102, which rotates integrally with the manual shaft 101. The manual spool valve 105 reciprocally moves in the axial direction thereby to switch over hydraulic pressure supply passages to a hydraulic clutch of the automatic transmission (not shown). As a result, a state of engagement of hydraulic clutches is switched over to change a shift range of the automatic transmission.

The detent plate 102 is formed recess parts 151, 152, 153 and 154. The recess parts 151 to 154 are provided to correspond to P-range, R-range, N-range and D-range among shift ranges of the automatic transmission, respectively. When a stopper 107 supported at the top end of a leaf spring 106 is engaged with either one of the recess parts 151 to 154, the position of the manual spool valve 105 in the axial direction is determined.

When the rotary actuator 1 applies rotary force to the detent plate 102 through the manual shaft 101, the stopper 107 moves to another adjacent recess part (either one of recess parts 151 to 154). Thus, the position of the manual spool valve 105 in the axial direction is varied. For example, when the manual shaft 101 is rotated in the clockwise direction viewed in a direction Y in FIG. 2, the pin 103 pushes the manual spool valve 105 into the hydraulic valve body 104 through the detent plate 102 so that the fluid passages in the hydraulic valve body 104 are switched over to D, N, R and P in this sequence. Thus, the shift range of the automatic transmission is switched in the order of D, N, R and P.

When the manual shaft 101 is rotated in the counter-clockwise direction, the pin 103 pulls out the manual spool valve 105 from the hydraulic valve body 104 so that the fluid passages in the hydraulic valve body 104 are switched over to P, R, N and D in this sequence. Thus, the shift range of the automatic transmission is switched in the order of P, R, N and D. Thus each rotary angle of the manual shaft 101, which is driven to rotate by the rotary actuator 1, that is, each predetermined position in the rotary direction, correspond to each shift range of the automatic transmission.

The parking switching mechanism 120 includes the parking rod 121, a parking pawl 123, a parking gear 126 and the like. The parking rod 121 is formed generally in a letter L-shape and its one end part is fixedly coupled to the detent plate 102. The other end part of the parking rod 121 is formed a conical part 122. The parking rod 121 converts the rotary movement of the detent plate 102 to a linear movement of the conical part 122 so that the conical part 122 reciprocally moves in the axial direction. The parking pawl 123 abuts the side face of the conical part 122. When the parking rod 121 reciprocally moves, the parking pawl 123 rotates about its axis part 124.

A protrusion part 125 is formed on the parking pawl 123 on a side, which is in the rotation direction and faces the peripheral surface of the parking gear 126. When this protrusion part 125 engages a wheel of the parking gear 126, the rotation of the parking gear 126 is restricted. Thus driving wheels of the vehicle are locked through a drive shaft, differential gear and the like, which are not shown. When the protrusion part 125 disengages from the wheel of the parking gear 126, the parking gear 126 is allowed to rotate and the driving wheels are unlocked.

The rotary actuator 1 is configured as described in detail below. As shown in FIG. 1, the rotary actuator 1 includes the casing 10, an input shaft 20, a motor 3, a reduction device 50, the output shaft 60, a bearing member 91, a sealing member 95 and the like. The casing 10 is formed of a front casing 11 and a rear casing 12. The front casing 11 and the rear casing 12 are formed of, for example, resin. The front casing 11 has a bottomed tubular part 13 and a support tubular part 14. The bottomed tubular part 13 is formed in a tubular shape, which has a bottom wall at one end thereof. The support tubular part 14 is formed integrally with the bottomed tubular part 13 at a bottom center of the bottomed tubular part 13. The rear casing 12 also has a bottomed tubular part 15. The bottomed tubular part 15 is formed in a tubular shape, which has a bottomed wall part at one end part.

The front casing 11 and the rear casing 12 are fixed to each other by a bolt 4, with one end part opposite to the bottom side of the bottomed tubular part 13 and one end part opposite to the bottom side of the bottomed tubular part 15 abutting each other. The front casing 11 and the rear casing 12 facing each other thus provides a space 5 therebetween. A gasket 6 is sandwiched at a position where the front casing 11 and the rear casing 12 abut each other. The gasket 6 is formed in an annular shape. The outside and the inside of the space 5 are maintained in air-tightly and fluid-tightly by the gasket 6.

The input shaft 20 has a large-diameter part 21 in the middle part f the input shaft 20, which is larger in diameter than in any other parts. The input shaft 20 further has a column-shaped eccentric part 22, which is provided eccentrically relative to a center of rotation of the input shaft 20 and adjacent to the large-diameter part 21 in the axial direction. The eccentric part 22 is provided eccentrically relative to the large-diameter part 21. The center axis C22 of the eccentric part 22 is thus deviated in the radial direction from the center axis C20 of the input shaft 20. The input shaft 20 is rotatably supported by front bearings 81 at its one end and by a rear bearing 82 at its other end. The front bearings 81 and the rear bearing 82 are ball bearings. Two front bearings 81 are arranged side by side in the axial direction.

The front bearings 81 are provided inside the output shaft 60 described later. The output shaft 60 is supported rotatably by a metal sheet bearing 83 made of metal, which is provided inside the support tubular part 14 of the front casing 11. That is, one end part of the input shaft 20 is supported rotatably by the metal bearing 83 provided in the support tubular part 14 of the front casing 11, the output shaft 60 and the front bearings 81. The other end part of the input shaft 20 is supported rotatably by the rear bearing 82 provided in the center of the bottom wall of the bottomed tubular part 15 of the rear casing 12. Thus the input shaft 20 is supported rotatably by the casing 10.

The motor 3 is a three-phase brushless motor, which generates drive power without using permanent magnets. The motor 3 is housed in the casing 10 and specifically provided mostly at the rear casing 12 side in the space 5.

The motor 3 includes a stator 30 and a rotor 40. The stator 30 is shaped generally annularly and press-fitted in a metal plate 7, which is insert-molded into the rear casing 12. The stator 30 is thus fixed to the rear casing 12 and not allowed to rotate.

The stator 30 is formed of a stator core 31 and three-phase coils 32. The stator core 31 is formed of a plurality of thin plates stacked in the plate thickness direction. A plurality of stator teeth is formed at every predetermined angular interval in the circumferential direction. Each of the stator teeth 33 protrudes towards a radially inner direction. The coils 32 are wound about the teeth 33.

The coils 32 are connected electrically to a bus bar part 70. The bus bar part 70 is provided in the bottom part of the bottomed tubular part 15 of the rear casing 12. The bus bar part 70 is made of, for example, metal to allow a current supplied to the coils 32 to flow. The bus bar part 70 has terminals 71, which are connected to the coils 32, at the radially inside part of the coils 32 wound on the stator 30. The coils 32 are connected electrically to the terminals 71. Electric power is supplied to the terminals 71 based on drive signals outputted from the ECU 2.

The rotor 40 is provided radially inside the stator 30. The rotor 40 is formed of a plurality of thin plates, which is stacked in the plate thickness direction. The rotor 40 is formed of a rotor core 41 and salient poles 42. The rotor core 41 is formed in generally an annular shape and press-fitted into the large-diameter part 21 of the shaft 21. The salient poles 42 are provided at every predetermined angular interval in the circumferential direction and protrude from the rotor core 41 toward the stator 30 in the radially outward direction. Since the rotor core 41 is press-fitted onto the input shaft 20, the rotor 40 is relatively rotatable against the casing 10 and the stator 30.

With electric power supplied to the coils 32, magnetic force is generated in the stator teeth 33, about which the coils 32 are wound. This magnetic force attracts the salient poles 42 of the rotor 40 to the stator teeth 33. The coils 32 form three phases, for example, U-phase, V-phase and W-phase. When the ECU 2 sequentially switches over power supply in the order of U-phase, V-phase and W-phase, the rotor 40 rotates in one circumferential direction. When the ECU 2 sequentially switches over power supply in the order of W-phase, V-phase and U-phase, the rotor 40 rotates in the other circumferential direction. The rotor 40 is thus rotated in an arbitrary direction by switching over power supply to each coil 32 and controlling the magnetic force generated in the stator teeth 33.

A rotary encoder 72 is provided between the rotor core 41 and the bottom part of the bottomed tubular part 15 of the rear casing 12. The rotary encoder 72 includes a magnet 73, a substrate 74, a Hall IC 75 and the like. The magnet 73 is formed in an annular shape and is a multi-pole magnet, which is magnetized to the N-pole and S-pole alternately in the circumferential direction. The magnet 73 is positioned coaxially with the rotor core 41 and is located at one side end part of the rotor 40 in a manner to face the rotary encoder 72 at the rear casing 12 side. The substrate 74 is fixed to the bottom wall surface of the bottomed tubular part 15 of the rear casing 12. The Hall IC 75 is mounted on the substrate 74 to face the permanent magnet 73.

The Hall IC 75 includes therein a Hall element and a signal conversion circuit. The Hall element is a magneto-electric transducer, which is a magneto-electric outputs an electrical angle proportional to the magnetic flux density of the magnetic field generated by the permanent magnets 73. The signal conversion circuit converts the output signal of the Hall element. The Hall IC 75 outputs a pulse signal to the ECU 2 through signal pins 76 in synchronism with the rotation of the rotor core 41. The ECU 2 is thus allowed to detect the direction of rotation and rotational angle based on the pulse signal from the Hall IC 75.

The reduction device 50 includes a ring gear 51 and a sun gear 52. The ring gear 51 is formed of a metal, for example, and in generally an annular shape. The ring gear 51 is press-fitted into the plate 8, which is an annular plate 8 insert-molded with the front casing 11. The ring gear 51 is thus fixedly attached to the casing 10. The ring gear 51 is fixed to the casing 10 so that the ring gear 51 is coaxial with the input shaft 20. The ring gear 51 has inner teeth 53 formed on the inner peripheral part.

The sun gear 52 is formed of metal, for example, and in generally a disk shape. The sun gear 52 has a column-shaped protrusion part 54, which protrudes in the plate thickness direction from a position distanced from the center of its one surface in the radial direction. The protrusion part 54 is provided at every predetermined angular interval in the circumferential direction of the sun gear 52. The sun gear 52 is formed external teeth 55 on its outer periphery to be engaged with the internal teeth 53 of the ring gear 51. The sun gear 52 is provided eccentrically and relatively rotatably against the input shaft 20 through middle bearings 84 provided on the outer periphery of the eccentric part 22 of the input shaft 20. Thus, when the input shaft 20 rotates, the sun gear 52 rotates inside the ring gear 51 and revolves with its external gear 55 engaged with the internal teeth 53 of the ring gear 51. Here, similarly to the front bearings 81 and the rear bearing 82, the middle bearings 84 are ball bearings and provided in a pair in the axial direction at the outer periphery of the eccentric part 22.

The output shaft 60 is formed of, for example, a metal. The output shaft 60 includes an output tubular part 61 formed in generally a tubular shape and a disk part 62 formed in generally a disk shape. The output tubular part 61 is rotatably supported by the support tubular part 14 through the metal bearing 83 provided inside the support tubular part 14 of the casing 11. The output tubular part 60 is provided to be coaxial with the large-diameter part 21 of the input shaft 20. The front bearings 81 are provided inside the output cylindrical part 61. Thus the output cylindrical part 61 rotatably supports the one end part of the input shaft 20 through the metal bearings 83 and the front bearing 81. A spline groove 64 is formed inside the output tubular part 61.

The disk part 62 is formed in a generally disk shape to expand in the radially outward direction from the one end of the output tubular part 61 in the space 5. The disk part 62 is formed a hole 63, which allows the protrusion part 54 of the sun gear 52 to enter therein. The hole 63 is formed by pressing to penetrate the disk part 62 in the thickness direction. The hole 63 is formed at plural locations in the circumferential direction of the disk part 62 in correspondence to the protrusion 54.

According to the above-described configuration, when the sun gear 52 rotates and revolves inside the ring gear 51, the inner wall of the hole 63 of the disk part 62 of the output shaft 60 is pressed in the circumferential direction of the disk part 62 by the outer wall of the protrusion part 54. Thus, the rotating component of the sun gear 52 is transferred to the output shaft 60. The speed of rotation of the sun gear 52 is slower than that of the input shaft 20. The rotation output of the motor 3 is thus reduced and outputted from the output shaft 60. The ring gear 51 and the sun gear 52 thus function as the reduction device 50. With the one end of the manual shaft 101 of the shift-by-wire system 100 being fitted in the spline groove 64 of the output shaft 60, the output shaft 60 and the manual shaft 101 are spline-coupled. Thus, since the rotation of the input shaft 20 is transferred after reduction of speed by the reduction device 50, the output shaft 60 outputs the rotary force of the motor 3 to the manual shaft 101.

A bearing member 91 is provided to be supported by the inside of the support tubular part 14. Specifically, the bearing member 91 is provided to be fitted inside a metallic tubular fixing member 92, which is insert-molded inside the support tubular part 14. The bearing member 91 is also a ball bearing similarly to the front bearing 81, the rear bearing 82 and the middle bearing 84.

As shown in FIG. 1, the rotary actuator 1 is attached to the housing 130 of the shift range switching mechanism 110 such that the end part of the manual shaft 101 is coupled to the inside of the output tubular part 61 of the output shaft 60. Specifically, a small-diameter part 111 is formed on the axial end part of the manual shaft 101, which is coupled with the manual shaft 101. The small-diameter part 111 is smaller in diameter than the other part of the manual shaft 101. A taper part 112 is formed on the end part of the small-diameter part 111 at a position opposite to the output shaft 60. The small-diameter part 111 and the taper part 112 are formed outside the housing 130. The inner diameter of the bearing member 91 is set to be generally equal to the outer diameter of the small-diameter part 111.

A spline groove 113 is formed on the outer wall of the one end of the manual shaft 101, that is, on the end part opposite to the taper part 112 of the small-diameter part 111. A corner part of the end part opposite to the taper part 112 of the small-diameter part 111 is chamfered. When the rotary actuator 1 is attached to the housing 130, the spline groove 64 of the output tubular part 61 of the output shaft 60 and the spline groove 113 of the manual shaft 101 are engaged and the output shaft 60 and the manual shaft 101 are spline-coupled. The bearing member 91 bears the small-diameter part 111 of the manual shaft 101.

The sealing member 95 is formed annularly of, for example, acrylic resin or heat-resistive and water-resistive rubber. The sealing member 95 is provided inside the support tubular par 14 of the front casing 11. The sealing member 95 has an outer diameter, which is generally equal to the inner diameter of the support tubular part 14, and an inner diameter, which is generally equal to the outer diameter of the small-diameter part 111 of the manual shaft 101. The sealing member 95 is capable of holding air-tightly or fluid-tightly the outer wall of the small-diameter part 111 of the manual shaft 101 and the inner wall of the support tubular part 14 under a state that the manual shaft 101 is coupled to the output tubular part 61 of the output shaft 60. The sealing member 95 is provided at the opposite side to the output tubular part 61 sandwiching the bearing member 91, that is, provided inside the end part, which is opposite to the bottomed tubular part 13 of the support tubular part 14.

As described above, the rotary actuator 1 according to the embodiment provides the following advantages.

(1) The manual shaft 101 of the shift range switching mechanism 110 is coupled with the inside of the output tubular part 61 of the output shaft 60 of the rotary actuator 1 and rotatably supported by the bearing member 91. That is, the output tubular part 61 and the bearing member 91 are both supported by the support tubular part 14 of the casing 10. For this reason, the output tubular part 61, the bearing member 91 and the manual shaft 101 can be maintained coaxially. When the rotary actuator 1 rotationally drives the manual shaft 101, the output shaft 60 and the manual shaft 101 can be held coaxially with less variation in the coaxial relation. It is thus possible to reduce prying and local wear at the coupling part between the output shaft 60 and the manual shaft 101, that is, at the location where the spline groove 64 and the spline groove 113 are fittingly engaged. As a result, erroneous operation and generation of wear powder can be suppressed.

(2) The sealing member 95 is provided in the inside of the support tubular part 14 to hold the manual shaft 101 and the support tubular part 14 air-tightly and fluid-tightly in the state that the manual shaft 101 is coupled to the output tubular part 61. It is thus possible to restrict fluid such as water and foreign particles from entering from an outside of the rotary actuator 1 and adhering to the coupling part between the output shaft 60 and the manual shaft 101. Rusting of the coupling part due to water and the like and biting of foreign particles in the coupling part can be suppressed. It is further possible to suppress, by the sealing member 95, fluid such as water and foreign particles from entering into the space 5 of the casing 10, in which the motor 3 and the like are housed. Failure of the motor 3 due to water and foreign particles or erroneous operation of the motor 3 due to biting of the foreign particles can be suppressed.

(3) The sealing member 95 is provided at a side opposite to the output tubular part 61 sandwiching the bearing member 91. It is thus possible to restrict fluid such as water and foreign particles entering from the outside of the rotary actuator 1 from adhering to the bearing member 91. Rusting of the bearing part 91 due to adhering of water and the like and erroneous bearing operation of the bearing member 91 due to biting of foreign particles can be suppressed.

(4) The reduction device 50 is provided to transfer the rotation of the input shaft 20 to the output shaft 60 by reducing the rotation of the input shaft 20.

The rotary actuator 1 is thus preferable to the shift-by-wire system 100 and the like, in which a torque of more than a predetermined value is needed to rotationally drive a shaft (manual shaft 101) of a driven object (shift range switching mechanism 110 or parking switching mechanism 120).

(Modification)

In the above-described embodiment, the sealing member is provided in the inside of the support tubular part and at the side opposite to the output tubular part sandwiching the bearing member. It is alternatively possible to provide the sealing member in the inside of the support tubular part and at the output tubular part side of the bearing member, that is, between the bearing member and the output tubular part. According to this modification, although fluid such as water and foreign particles are likely to adhere to the bearing member, it is suppressed that the fluid such as water and the foreign particles adhere to the coupling part between the output shaft and enter into the inside of the casing housing the motor and the like therein. Further, the sealing member need not be provided.

In the above-described embodiment, the reduction device is provided to transfer the rotation of the input shaft to the output shaft by reducing the rotation speed. It is alternatively possible to provide, in place of the reduction device, an acceleration device, which transfers the rotation of the input shaft to the output shaft by increasing the rotation. It is also possible to provide, in place of the reduction device, a device, which transfers the rotation of the input shaft to the output shaft at the same rotation speed. It is further possible to integrally couple the input shaft and the output shaft without the reduction device, the acceleration device and the like, so that no relative rotation is caused between the input shaft and the output shaft. That is, it is only necessary that the output shaft outputs the rotary force of the motor to the shaft of the driven object by transferring the rotation of the input shaft.

In the above-described embodiment, the rotary actuator is attached to the housing of the shift-range switching mechanism. It is alternatively possible to attach the rotary actuator to a fixture part other than the housing of the shift range switching mechanism or an outer wall of the apparatus. The motor is not limited to the three-phase motor but may be other types of motors. The rotary actuator may be applied to drive other apparatuses, which are different from the shift range switching mechanism or the parking switching mechanism of the shift-by-wire system of the vehicle. The rotary actuator is not limited to the above-described embodiment and modifications but may be implemented in other forms of embodiments.

What is claimed is:

1. A rotary actuator for rotationally driving a driven shaft of a driven object, the rotary actuator comprising:
a casing having a support tubular part;
an input shaft supported rotatably by the casing;
a motor housed in the casing to rotationally drive the input shaft;
an output shaft having an output tubular part formed in a tubular shape, inside of which an end of the driven shaft is coupled, and supported rotatably inside the support tubular part, the output shaft receiving rotation of the input shaft and outputting rotary force of the motor to the driven shaft; and
a bearing member provided to be supported inside the support tubular part and rotatably supporting the driven shaft in a state that the driven shaft is coupled to the output tubular part.

2. The rotary actuator according to claim 1, further comprising:
a sealing member provided inside the support tubular part to air-tightly and fluid-tightly hold a space between the driven shaft and the support tubular part in a state that the driven shaft is coupled to the output tubular part.

3. The rotary actuator according to claim 2, wherein:
the sealing member is provided at a side opposite to the output tubular part sandwiching the bearing member.

4. The rotary actuator according to claim 1, further comprising:
a reduction device for transferring rotation of the input shaft to the output shaft after reduction of rotation.

5. The rotary actuator according to claim 1, wherein:
the outer tubular part and the driven shaft have respective spline grooves, which are engaged with each other to couple the outer tubular part and the driven shaft.
